(19) United States
(12) Patent Application Publication
(10) Pub. No.: US 2007/0181350 A1
(43) Pub. Date: Aug. 9, 2007

(54) On-board truck scale

(75) Inventors: Mark J. Kranz, Hallsville, TX (US); Bill Sphatt, Longview, TX (US); Michael James Massey, Longview, TX (US)

Correspondence Address: KILPATRICK STOCKTON LLP, 607 14TH STREET, N.W., WASHINGTON, DC, 20005, US

(73) Assignee: STEMCO LP

(21) Appl. No.: 11/701,368

(22) Filed: Feb. 2, 2007

Related U.S. Application Data
(60) Provisional application No. 60/771,479, filed on Feb. 9, 2006.

(51) Int. Cl. G01G 19/08

(52) U.S. Cl. 177/136

(57) ABSTRACT

A system and method that can provide a measurement of the weight on a trailer or vehicle, e.g., a truck or rig. The system and method can be implemented on systems that are equipped with air suspension, as well as those without air suspension, unlike conventional systems that require air suspension systems for installation. Additionally, the system and method can yield gross trailer weight, even if the truck is not instrumented. Further, the system and method can provide axle weight on properly equipped axles. A system for measuring weight on a trailer of a vehicle has a sensor system having a plurality of sensors, wherein each sensor is attached to an axle of the trailer or the vehicle. A microcontroller receives a transmission of strain change from a sensor. A display unit displays a calculated weight on the trailer from the microcontroller.

### CROSS-REFERENCE TO RELATED APPLICATIONS

This application claims priority to U.S. Provisional Patent Application No. 60/771,479, filed Feb. 9, 2006, which is hereby incorporated by reference in its entirety.

### FIELD OF THE INVENTION

This invention relates generally to a scale for measuring the weight on a trailer or vehicle.

### BACKGROUND OF THE INVENTION

Conventional systems for determining the weight on a truck use the self-leveling capability of air suspension systems to calculate weight at the axles. In order for the units to measure gross trailer weight, the tractor and trailer must be instrumented. The installation process for these conventional systems also involves connecting the instrumentation to the air system. As a result, the conventional systems can be expensive and wiring may be required on the truck and trailer.

In one example of a conventional system, an Air-Weigh system has a kit including a scale, a pressure sensor assembly, sensor and power cables, and mounting fasteners. The kit is installed on each trailer suspension. The pressure sensor is installed in the air suspension line. By calibrating and measuring the suspension air pressure, the Air-Weigh system can measure the weight.

In another example of a conventional system, a Truck Weight system measures pressure and temperature changes in the air suspension system. A sensor is mounted to the frame of the truck and/or trailer, which is then connected to the air suspension line with tubing. After calibrating, the system sends pressure and temperature information to a handheld receiver.

Other conventional methods are also available. For example, a truck can use a simple air gauge. However, it is not accurate and does not account for temperature.

### SUMMARY OF THE INVENTION

What is desired is a system and method that can provide a measurement of the weight on a trailer or on a vehicle, e.g., a truck or rig. The system and method can be implemented on systems that are equipped with air suspension, as well as those without air suspension, unlike conventional systems that require air suspension systems for installation. Additionally, the system and method can yield gross trailer weight, even if the truck is not instrumented, i.e., installing a sensor on the air suspension line. Further, the system and method can provide axle weight on properly equipped axles.

In one embodiment, a system for measuring weight on a trailer of a vehicle comprises a sensor system having a plurality of sensors, wherein each sensor is attached to an axle of the trailer or the vehicle. A microcontroller receives a transmission of strain change from a sensor. A display unit displays a calculated weight on the trailer from the microcontroller.

In another embodiment, a method for measuring weight on a trailer of a vehicle comprises the steps of measuring the strain at two or more locations on the vehicle, determining a strain difference since a previous tare cycle, calculating the bending moment, and displaying on a display unit the weight on the trailer.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The present invention will be more clearly understood from a reading of the following description in conjunction with the accompanying exemplary figures wherein:

FIG. 1 shows a mass on a truck and trailer, according to an exemplary embodiment of the present invention;

FIG. 2 shows an instrumentation of a sensor on an axle, according to an exemplary embodiment of the present invention;

FIG. 3 shows a circuit block diagram of a strain sensor, according to an exemplary embodiment of the present invention; and

FIG. 4 shows a circuit block diagram of a central data collection and display unit, according to an exemplary embodiment of the present invention.

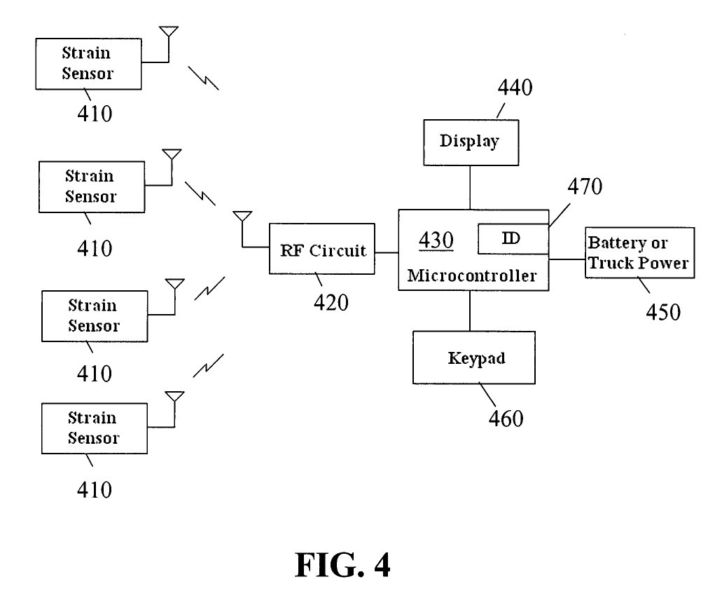

### DETAILED DESCRIPTION

Reference will now be made in detail to the preferred embodiments of the present invention, examples of which are illustrated in the accompanying drawings.

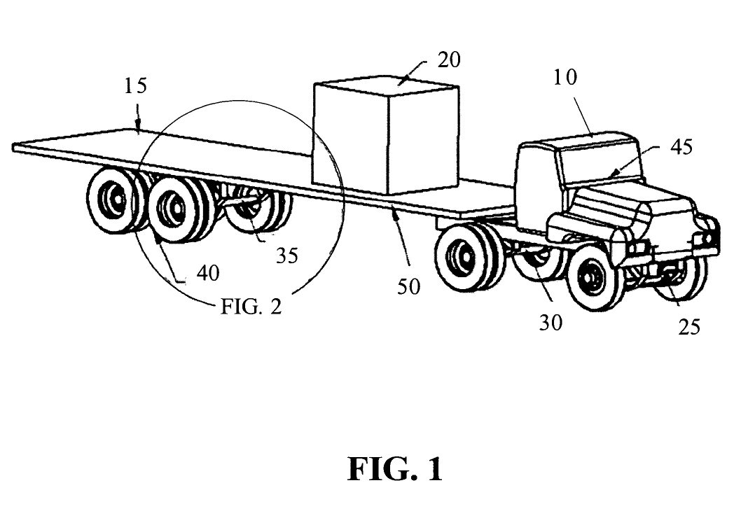

Referring to FIG. 1, a truck 10 and a trailer 15 having a mass 20 thereon are shown. A sensor system having at least one sensor can be mounted on an axle or on a supporting structure of the subframe near a fifth wheel mount location on a trailer. In the exemplary embodiment, the sensor system has a plurality of sensors strategically located through the truck 10 and trailer 15. However, the sensors can be located on only the truck, only the trailer, or both the truck and trailer.

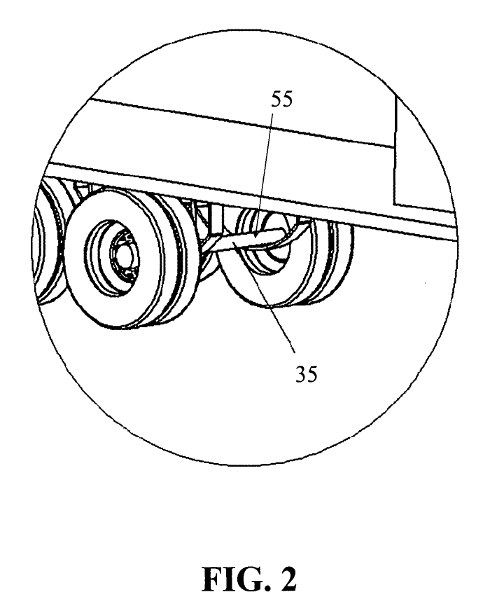

In order to measure only the axle weight, sensors can be mounted on the axles of the vehicle. Preferably, the sensors are positioned to measure the strain at the axles or, optionally, a fifth wheel connection point. In FIG. 1, a sensor can be located at a front truck axle 25, a rear truck axle 30, a front trailer axle 35, and/or a rear trailer axle 40. Referring to FIG. 2, an exploded view of the position 35 of a sensor on a rear trailer axle 55 is shown. Each sensor has a wireless link to communicate weight to a master display in a position 45 located in the truck 10, a position 50 located on the trailer 15, or other suitable locations.

By measuring the strain at the locations of the sensors, the system can calculate the bending moment in order to calculate the weight of the object on the trailer. The system senses, calculates, and tracks strain on the axle or frame of a truck or trailer at each position of the sensor. The sensor uses a strain gauge, e.g., a silicon strain gauge or other semiconductor strain gauge, using the stress and temperature at that location to measure the strain. The sensor tracks the strain relative to temperature, drift, and creep, and provides a sum total of strain since the last tare cycle. The user can tare at any time to obtain a change in strain since the last measurement. The sensor then communicates this information to a display unit on the trailer or truck. In order to provide information to the user that satisfies the Department of Transportation, the display unit preferably displays the weight of the axles, the weight at the front of the truck or trailer, the weight at the rear of the truck or trailer, and the gross vehicle weight, which is a combination of these weights.

The strain gauges are mounted on a board that can be clamped to the object being measured. By clamping the strain gauge board to the object being measured, e.g., an axle, the system can be quickly installed and an operator no longer needs to use glue or other adhesive. Because the device is wireless, no further communications wiring need to be configured; only the mounting brackets are to be tightened. The strain gauge is mounted onto either side of a printed circuit board, e.g., in a half bridge configuration, having sensor conditioning electronics and an RF transceiver. This board having a strain gauge is then clamped to the axle or attached using any other method known in the art. Multiple boards clamped to the trailer or truck can communicate the change in strain to a microcontroller for calculation of weight. This system, with or without the use of wires, can measure strain or weight in almost any section of the truck or trailer, without instrumenting the truck or trailer.

In one exemplary embodiment, the weight can be calculated based upon a change in voltage in the strain gauges. The strain gauges can be attached in a bridge configuration to a trailer as described above. In one method of calculation, a voltage of an empty trailer can be noted. For example, the voltage of an empty trailer can be 0.2 volts. Additionally, it can be helpful to know the empty trailer weight, e.g., 2000 lbs on each axle. A known load, e.g., 10,000 lbs, is then applied to the trailer. If the change in voltage is 2 volts, then each volt equates to about a 5,000 lb change in load. A ratiometric scale of voltage per pounds can be used to calculate the weight of a load based on the change in voltage from the strain gauges.

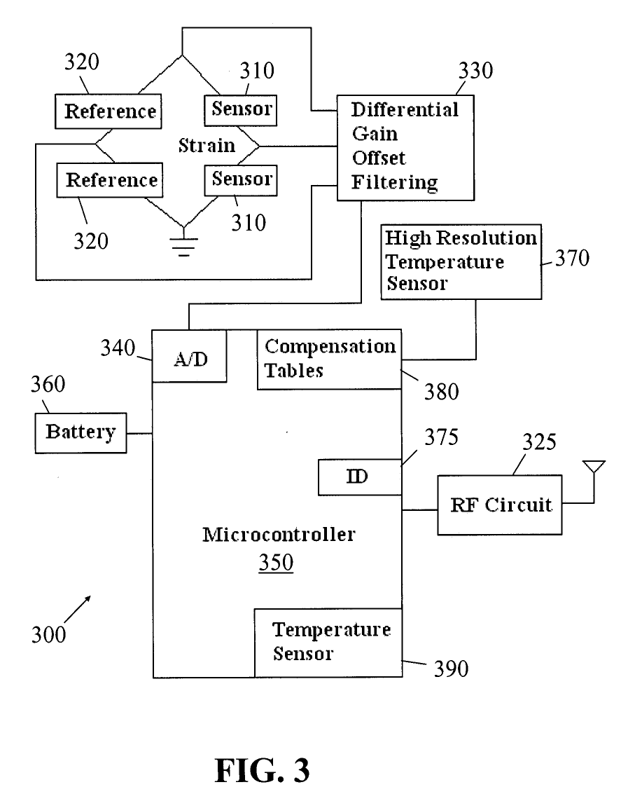

Referring to FIG. 3, a block diagram for a sensor 300 is shown. The sensor 300 has at least one strain gauge 310 to measure strain. At least one resistor 320 creates a reference for the strain. A voltage signal from the strain gauge 310 and reference resistor 320 is transmitted to a circuit 330 having a differential operational amplifier, an offset circuit for eliminating any offset between the strain gauge and the reference resistor, and an analog filter or anti-alias filter. The signal then passes to an analog/digital converter 340 of a microcontroller 350, which can be powered by a battery 360.

A high resolution temperature sensor 370 determines the temperature of the strain gauge 310 and provides the temperature to compensation tables 380, which can account for changes in temperature, aging, and the like. A temperature sensor 390 accounts for other temperature issues, such as RF variations with temperature or gross temperature changes, and compensates for the gain, offset and filtering of circuit 330.

At least one sensor can be used to track the strain at the sensor locations. A microcontroller 430 receives a signal from each sensor 410 through an RF circuit 420. In this exemplary embodiment, the system operates wirelessly with a radio link, but could be hard-wired as known to one of ordinary skill in the art. The microcontroller 430 calculates the weight and communicates the weight to a display 440. The microcontroller 430 can be powered by a battery or truck power 450, or other power means known to one of ordinary skill in the art. An operator can communicate with the microcontroller 430 using a keypad 460 and/or interacting through the display 440.

When using wireless communication between the sensors 410 and the microcontroller 430, it is desirable for the truck 10 to maintain communication with only the corresponding trailer 15. If a plurality of trucks and trailers are outfitted with the sensors, it is important that the trailer communicates with the corresponding truck and does not confuse the systems of other trucks nearby. In order to identify the corresponding trailer, the RF system binds, i.e., acknowledges, the corresponding truck. The microcontroller 430 has an ID 470 that recognizes the corresponding ID 375 of sensors on a trailer. Through software coding, the microcontroller can identify which sensors are on the truck and trailer without confusion from other trucks, trailers, or other nearby vehicles. As a result, the system does not require different instrumentation for multiple vehicles.

Software coding can also address other considerations including, but not limited to, temperature changes, creep, drift, sensing truck motion, binding the radio communication to an unknown truck, user interface, changes in load due to weather, stiffness of trailer, measurement resolution, large dynamic ranges of weight measurement, placement of load adjustment, power supply and voltage changes, mounting, electrical noise, parking on a hill, and the age of the system.

The method and system of the present invention measure can measure trailer and truck weight. Preferably, no connecting wires to sensors are needed because the sensors communicate wirelessly, e.g., via RF transceivers. Autolearning algorithms can allow for simple calibration procedures. Also, the system quickly installs and retrofits without compromising existing systems, e.g., air systems.

The embodiments described above are intended to be exemplary. One skilled in the art recognizes that numerous alternative components and embodiments that may be substituted for the particular examples described herein and still fall within the scope of the invention.

What is claimed is:

1. A system for measuring weight on a trailer of a vehicle, the system comprising:
a sensor system comprising a plurality of sensors, wherein each sensor is attached to an axle of the trailer or the vehicle;
a microcontroller for receiving a transmission of strain change from a sensor and for calculating the weight on the trailer; and
a display unit for displaying from the microcontroller a calculated weight on the trailer.

2. The system according to claim 1, wherein at least one of the plurality of sensors are positioned on the vehicle.

3. The system according to claim 1, wherein at least one of the plurality of sensors are positioned on the trailer.

4. The system according to claim 1, further comprising a first sensor and a second sensor positioned on a first axle and a second axle of the vehicle, respectively.

5. The system according to claim 1, further comprising a third sensor and a fourth sensor are positioned on a first axle and a second axle of the trailer, respectively.

6. The system according to claim 1, further comprising a sensor positioned substantially proximate to a fifth wheel connection point.

7. The system according to claim 1, wherein the vehicle has an air suspension.

8. The system according to claim 1, wherein the vehicle does not have an air suspension.

9. The system according to claim 1, wherein each sensor comprises a strain gauge.

10. The system according to claim 9, wherein the strain gauge is a semiconductor strain gauge.

11. The system according to claim 9, further comprising a temperature sensor for determining temperature of the strain gauge.

12. The system according to claim 1, further comprising a wireless link on each of the plurality of sensors.

13. The system according to claim 1, further comprising an RF system that temporarily binds the truck with the trailer.

14. A method for measuring weight on a trailer of a vehicle, the method comprising the steps of:
measuring the strain at two or more locations on the vehicle;
determining a strain difference since a previous tare cycle;
calculating the bending moment; and
displaying on a display unit the weight on the trailer.

15. The method according to claim 14, wherein the step of displaying further comprises displaying the weight of an at least one axle.

16. The method according to claim 14, wherein the step of displaying further comprises displaying the weight of a front portion of the trailer.

17. The method according to claim 14, wherein the step of displaying further comprises displaying the weight of a rear portion of the trailer.

18. The method according to claim 14, wherein the step of displaying further comprises displaying the gross vehicle weight.

19. The method according to claim 14, further comprising the step of clamping a strain gauge at the location where strain is to be measured.

20. The method according to claim 14, further comprising the step of transmitting a change in strain to a microcontroller.

21. The method according to claim 19, further comprising the step of determining a temperature of the strain gauge and adjusting the strain measurement based upon the temperature.

22. The method according to claim 14, further comprising the step of binding the vehicle with the trailer.
